(19) United States
(12) Patent Application Publication
(10) Pub. No.: US 2020/0257642 A1
(43) Pub. Date: Aug. 13, 2020

(54) SEAMLESS I/O IN FIBRE CHANNEL POINT TO POINT TOPOLOGY WHILE A STORAGE PORT IS CHANGED

(71) Applicant: International Business Machines Corporation, Armonk, NY (US)

(72) Inventors: Kiran K. Anumalasetty, Bangalore (IN); Vinod K. Boddukuri, Hyderabad (IN); Sanket Rathi, Hyderabad (IN); Sudhakar Tadi, Hyderabad (IN)

(21) Appl. No.: 16/269,648

(22) Filed: Feb. 7, 2019

(51) Int. Cl. G06F 13/40; G06F 13/16

(52) U.S. Cl. CPC G06F 13/4027; G06F 13/1668

(57) ABSTRACT

A computer-implemented method, a computer program product, and a computer system for seamless I/O in Fibre Channel point to point topology while a target (or storage) port is changed. The target returns a first World Wide Port Name for a first target port to a pool of World Wide Port Names for ports on the target, in response to detecting that a Fibre Channel link between an initiator port and the first target port is down. The target detects a connection between the initiator port and a second target port. The target determines whether the initiator port issues a request of an initiator initiated Fabric login for connecting to the second target port. In response to determining that the request is issued, the target performs the initiator initiated Fabric login. In response to determining that the request is not issued, the target performs a target initiated Fabric login.

### BACKGROUND

The present invention relates generally to Fibre Channel point to point topology, and more particularly to seamless I/O in Fibre Channel point to point topology while a storage port is changed.

Fibre Channel (FC) is a high-speed data transfer protocol, primarily used to connect computer data storage to servers. The industry decided to use the British English “fibre” for the name of the standard. There are three major types of FC topology, namely, point to point topology, arbitrated loop topology, and switched fabric topology. FC point to point topology is widely used in the industry with the advent of low latency storage such as flash storage. Customers are increasingly using FC in direct attach flash storage to a host, to get high dedicated bandwidth and maximum input/output (I/O) operations per second (IOPS) for I/O intense workloads. These workloads often do not require a storage area network (SAN) and performs well with direct attach low latency storage such as flash storage. Customers tend to avoid an FC switch in order to minimize infrastructure cost, and instead use FC point to point topology to facilitate direct attach of storage to a host.

In the FC protocol, a World Wide Port Name (WWPN) is an identifier to identify an FC port. Most of initiators (hosts) recover from short duration of link bounce (cable disconnect and reconnect), if they find that the same port with same WWPN is available again after link up (reconnect). Generally, after linking up and performing FC logins, an initiator (host) verifies whether the same port with the same WWPN is found at a target (storage server), and then the initiator continues I/O. If the same port with the same WWPN is not found at the target, then the initiator (host) fails I/O and application downtime is experienced.

Multiple target ports on a target (storage server) is most common configuration. It is possible that a set of ports on the target (storage server) go into different SANs or different FC topologies. Following scenarios may require an FC direct attach cable to be moved from one port on the target (storage server) to other ports on the target (storage server): (a) change in configuration requirements, (b) consolidation of the bandwidth utilization on the target (storage server) across controllers or individual ports, (c) consolidation of ports on the target (storage server), and (d) storage controller maintenance (e.g., controller firmware update). If a direct attach port on the target (storage server) has to be relinquished and a connection of the direct attach port has to be moved to a different port on the target (storage server), it causes I/O application to be interrupted.

### SUMMARY

In one aspect, a computer-implemented method for seamless I/O in Fibre Channel point to point topology is provided. The computer-implemented method is implemented by a target. The computer-implemented method includes returning a first World Wide Port Name for a first port on the target to a pool of World Wide Port Names for ports on the target, in response to detecting that a Fibre Channel link between a port on an initiator and the first port on the target is down; detecting a connection between the port on the initiator and a second port on the target; determining whether the port on the initiator issues a request of an initiator initiated Fabric login for connecting to the second port on the target; performing the initiator initiated Fabric login, in response to determining that the port on the initiator issues the request of the initiator initiated Fabric login; and performing a target initiated Fabric login, in response to determining that the port on the initiator does not issue the request of the initiator initiated Fabric login.

In another aspect, a computer program product for seamless I/O in Fibre Channel point to point topology is provided. The computer program product comprising one or more computer-readable tangible storage devices and program instructions stored on at least one of the one or more computer-readable tangible storage devices. The program instructions are executable to return, by a target, a first World Wide Port Name for a first port on the target to a pool of World Wide Port Names for ports on the target, in response to detecting that a Fibre Channel link between a port on an initiator and the first port on the target is down. The program instructions are further executable to detect, by the target, a connection between the port on the initiator and a second port on the target. The program instructions are further executable to determine, by the target, whether the port on the initiator issues a request of an initiator initiated Fabric login for connecting to the second port on the target. The program instructions are further executable to perform, by the target, the initiator initiated Fabric login, in response to determining that the port on the initiator issues the request of the initiator initiated Fabric login. The program instructions are further executable to perform, by the target, a target initiated Fabric login, in response to determining that the port on the initiator does not issue the request of the initiator initiated Fabric login.

In yet another aspect, a computer system for seamless I/O in Fibre Channel point to point topology is provided. The computer system comprises one or more processors, one or more computer readable tangible storage devices, and program instructions stored on at least one of the one or more computer readable tangible storage devices for execution by at least one of the one or more processors. The program instructions are executable to: return, by a target, a first World Wide Port Name for a first port on the target to a pool of World Wide Port Names for ports on the target, in response to detecting that a Fibre Channel link between a port on an initiator and the first port on the target is down; detect, by the target, a connection between the port on the initiator and a second port on the target; determine, by the target, whether the port on the initiator issues a request of an initiator initiated Fabric login for connecting to the second port on the target; perform, by the target, the initiator initiated Fabric login, in response to determining that the port on the initiator issues the request of the initiator initiated Fabric login; and perform, by the target, a target initiated Fabric login, in response to determining that the port on the initiator does not issue the request of the initiator initiated Fabric login.

### BRIEF DESCRIPTION OF THE SEVERAL VIEWS OF THE DRAWINGS

FIG. 1 is a systematic diagram illustrating a set up of Fibre Channel point to point topology, in accordance with one embodiment of the present invention.

FIG. 2 is a systematic diagram illustrating seamless I/O in Fibre Channel point to point topology while a port on a target is changed, in accordance with one embodiment of the present invention.

FIG. 3(A) and FIG. 3(B) present a flowchart showing operational steps of seamless I/O in Fibre Channel point to point topology while a port on a target is changed, in accordance with one embodiment of the present invention.

FIG. 4 is a diagram illustrating components of a computing device, in accordance with one embodiment of the present invention.

### DETAILED DESCRIPTION

Embodiments of the present invention disclose an approach by which a target (or storage server) facilitates uninterrupted I/O in a case of moving a Fibre Channel (FC) direct attach connection from one port on the target to another port on the target. In this document, the terms of “port on a target”, “storage port”, and “target port” are interchangeable; the terms “port on an initiator”, “host bus adapter (HBA) port” and “initiator port” are interchangeable.

Using multiple I/O paths (MPIO) from a host may be an alternative. When one I/O path fails due to failure of a port on the target, MPIO software fails over I/O to another path through a different port on the target. However, not all customers use MPIO for a direct attach configuration. In such a case, adding additional I/O paths on the fly to achieve target port consolidation will be a difficult task. The reason is that adding additional path dynamically requires to add a new host bus adapter (HBA) port and make Logical Unit Number (LUN) Masking settings on the target (storage server).

Embodiments of the present invention disclose an approach that is on the target (storage server) side as opposed to the host side in the MPIO. The advantage of the target (storage server) side solution is that the target port failure will not result in I/O failure on the host and hence will not result in path failover. The present invention complements the MPIO solution but doesn't contradict the MPIO solution.

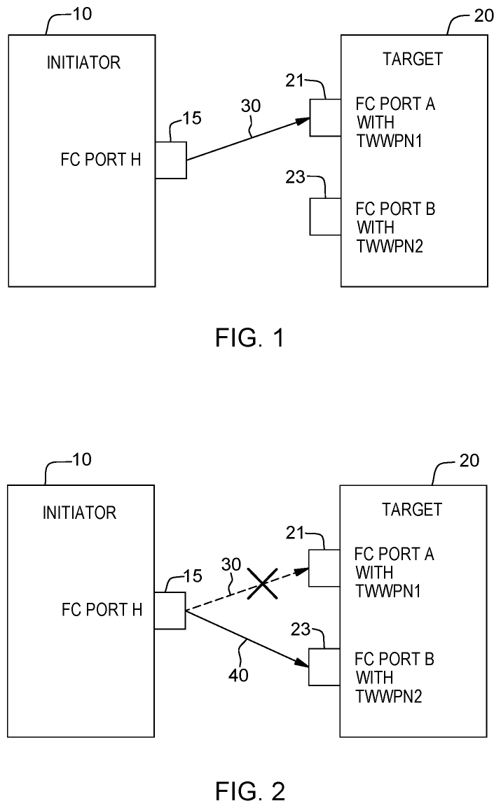

FIG. 1 is a systematic diagram illustrating a set up of FC point to point topology, in accordance with one embodiment of the present invention. As shown in FIG. 1, FC port H 15 on initiator (or host) 10 is connected to FC port A 21 on target (or storage server) 20 in FC point to point topology. The connection between FC port H 15 on initiator 10 and FC port A 21 on target 20 is illustrated by arrow 30. A World Wide Port Name (WWPN) is assigned to FC port A 21 by target 20; the WWPN assigned to FC port A 21 is TWWPN1 as shown in FIG. 1. Target 20 has another available port—FC port B 23. A different WWPN is assigned to FC port B 23 by target 20; the WWPN assigned to port B 23 is TWWPN2 as shown in FIG. 1. For an illustrative purpose, FIG. 1 shows only one FC port on initiator 10 and two FC ports on target 20. It should be understood that either initiator 10 or target 20 may have more FC ports than shown in FIG. 1.

In the Fibre Channel protocol, an FC port is identified by a World Wide Port Name (WWPN). A target (storage server) also identify an initiator (host) by an initiator port's WWPN used in a Fabric login (FLOGI) request or response by the initiator. All the FC host bus adapter (HBA) ports provide a way to specify WWPNs in their FLOGI requests or responses. On the target side, a pool of all WWPNs will be created by reading WWPN of each FC target port, and a WWPN for a FC target port from the pool will be assigned with the following method. When an FC direct attach cable is first time connected or an FLOGI starts on an FC target port, one WWPN is used from the pool and will be assigned forever for the FC target port if the connection is not point to point. In a case of FC point to point topology, a WWPN assigned to the FC target port will be given back to the pool if the FC link is down; this WWPN (which is given back to the pool) will be used again for the FC target port when the same initiator appears again. A point to point mapping table on the target (storage server) is maintained to define mapping of WWPNs of FC target ports to WWPNs of FC initiator ports. The table shows that a specific WWPN of an FC target port is exclusively used by a specific WWPN of an FC initiator port. In FC point to point topology, the target (storage server) will use the same WWPN of FC target ports for the FC initiator port. In FC point to point topology, if the initiator (which has been connected to the FC target port) is disconnected, then the WWPN (which has been assigned to the FC target port) will be used last by the target (storage server) for another FC target port. This means that the WWPN will be reserved until all other WWPNs in the pool are used by other FC target ports. If the same initiator comes back before the WWPN is used by other FC target ports, then the WWPN will be used for another FC target port connecting to the initiator. In the following paragraphs, an approach is described in detail; the approach is used to maintain the same WWPN for the FC target port when an FC link between the FC target port and the initiator is down.

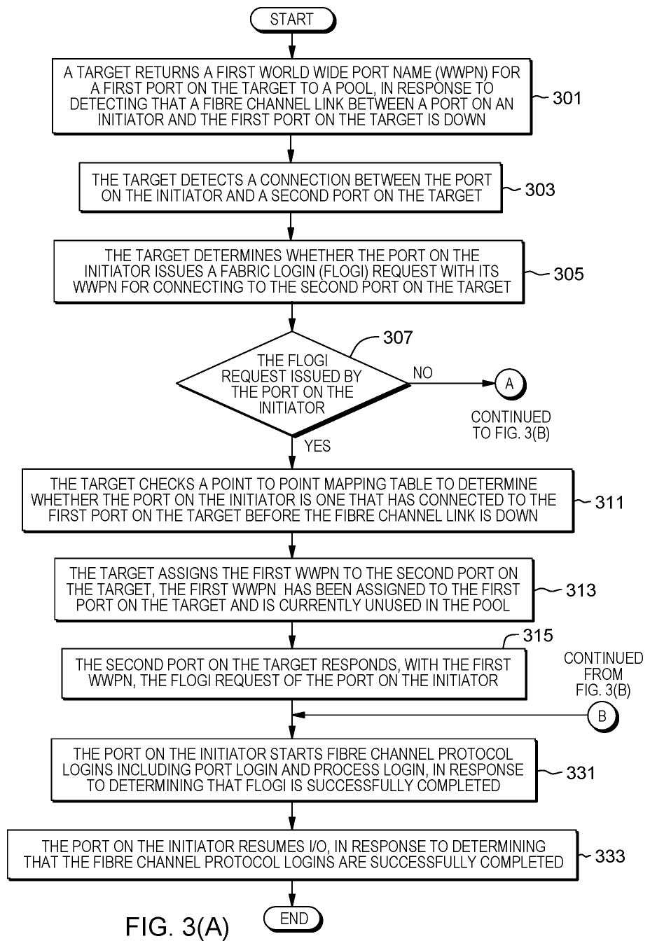

FIG. 2 is a systematic diagram illustrating seamless I/O in Fibre Channel point to point topology while a port on a target is changed, in accordance with one embodiment of the present invention. As shown in FIG. 1, initially, FC port H 15 on initiator 10 is connected to FC port A 21 on target 20, illustrated by arrow 30. In some scenarios, such as change in the configuration requirements, consolidation of the bandwidth utilization on the target, consolidation of target ports, and storage controller maintenance, the connection between FC port H 15 and FC port A 21 is disconnected. After an FC direct attach cable is disconnected from FC port A 21 on target 20, initiator 10 detects an FC link down event and waits for a certain timeout period giving a chance for target 20 to come up. Target 20 also detects the FC link down event. When the FC direct attach cable is connected to FC port B 23 on target 20, target 20 detects that FC port H 15 on initiator 10 is connected to FC port B 23 on target 20. FIG. 2 shows the disconnection and also shows that FC port H 15 on initiator 10 is connected to FC port B 23 on target 20. The connection between FC port H 15 on initiator 10 and FC port B 23 on target 20 is illustrated by arrow 40. When a cable is moved from FC port A 21 on target 20 to FC port B 23 on target 20, target 20 identifies intelligently that the same FC point to point connection is moved from FC port A 21 to FC port B 23, and presents to initiator 10 that the WWPN is unchanged (i.e., FC port B 23 presents the WWPN of FC port A 21 to FC port H 15 on initiator 10). This causes initiator 10 to resume its I/O through FC port B 23 without any failures.

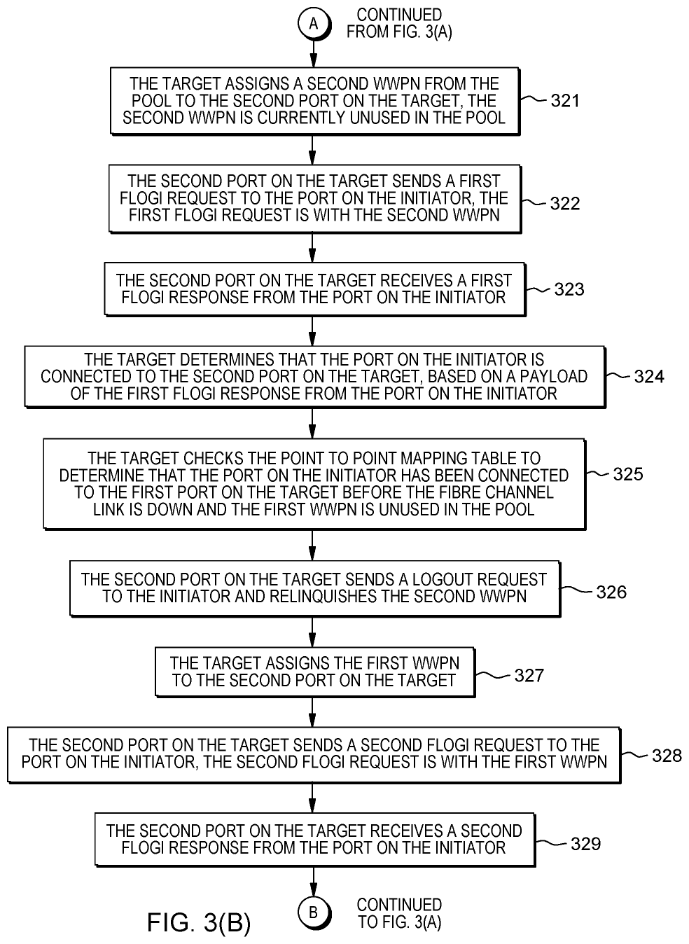

FIG. 3(A) and FIG. 3(B) present a flowchart showing operational steps of seamless I/O in Fibre Channel point to point topology while a port on a target is changed, in accordance with one embodiment of the present invention.

Referring to FIG. 3(A), at step 301, a target returns a first World Wide Port Name (WWPN) for a first port on the target to a pool, in response to detecting that a Fibre Channel (FC) link between a port on an initiator and the first port on the target is down. The pool stores FC WWPNs of FC ports on the target. In the embodiment shown in FIG. 2, target 20 returns TWWPN1 for FC port A 21 to the pool, in response to detecting that an FC link between FC port H 15 on initiator 10 and FC port A 21 on target 20 is down.

Referring to FIG. 3(A), at step 303, target detects a connection between the port on the initiator and a second port on the target. In the embodiment shown in FIG. 2, target 20 detects the connection between FC port H 15 on initiator 10 and FC port B 23 on target 20.

Referring to FIG. 3(A), at step 305, the target determines whether the port on the initiator issues a Fabric login (FLOGI) request with its WWPN for connecting to the second port on the target. In the embodiment shown in FIG. 2, target 20 determines whether FC port H 15 on initiator 10 issues the FLOGI request for connecting to FC port B 23 on target 20.

After detecting the connection between the port on the initiator and the second port on the target, either the initiator (e.g., initiator 10) or the target (e.g., target 20) may initiate a Fabric login (FLOGI). In the YES branch of decision block 307, the target (e.g., target 20) handles a case that the initiator (e.g., initiator 10) initiates the Fabric login (FLOGI); the operational steps in this case are steps 311, 313, and 315 (shown in FIG. 3(A)). In the NO branch of decision block 307, the target (e.g., target 20) handles a case that the target (e.g., target 20) initiates the Fabric login (FLOGI); the operational steps in this case are steps 321-329 (shown in FIG. 3(B)).

Referring to FIG. 3(A), in response to determines that the port on the initiator issues the FLOGI request for connecting to the second port on the target (YES branch of block 307), at step 311, based on the WWPN (which is included in a payload of the FLOGI request) of the port on the initiator, the target checks a point to point mapping table to determine whether the port on the initiator is one that has connected to the first port on the target before the FC link is down. In the embodiment shown in FIG. 2, target 20 checks the point to point mapping table to determine whether FC port H 15 on initiator 10 is one that has connected to FC port A 21 on target 20 before the FC link is down.

Referring to FIG. 3(A), if the port on the initiator issuing the FLOGI request for connecting to the second port on the target is the one having connected to the first port on the target, at step 313, the target assigns the first WWPN to the second port on the target. The first WWPN has been assigned to the first port on the target before the FC link is down and is currently unused in the pool. In the embodiment shown in FIG. 2, target 20 assigns TWWPN1 to FC port B 23 on target 20.

Referring to FIG. 3(A), at step 315, the second port on the target responds, with the first WWPN, the FLOGI request of the port on the initiator. In the embodiment shown in FIG. 2, FC port B 23 on target 20 responds, with TWWPN1, the FLOGI request of FC port B 23 on target 20. Thus, the initiator initiated FLOGI is completed successfully.

Referring to FIG. 3(A), at step 331, the port on the initiator starts FC protocol logins, in response to determining that FLOGI is successfully completed. The FC protocol logins include a port login (PLOGI) and a process login (PRLI). At step 333, the port on the initiator resumes I/O in the FC point to point topology, in response to determining that the FC protocol logins (including PLOGI and PRLI) are successfully completed. Thus, the FC link is re-established. In the embodiment shown in FIG. 2, FC port H 15 on initiator 10 starts the FC protocol logins and resumes I/O in the FC point to point topology.

Referring to FIG. 3(A), in response to determines that the port on the initiator does not issue the FLOGI request for connecting to the second port on the target (NO branch of block 307), the operating steps will continue, from C) in FIG. 2(A) to C) in FIG. 2(B). Referring to FIG. 3(B), at step 321, the target assigns a second WWPN from the pool to the second port on the target. The second WWPN is currently unused in the pool. In the embodiment shown in FIG. 2, target 20 assigns TWWPN2 from the pool to FC port B 23 on target 20.

Referring to FIG. 3(B), at step 322, the second port on the target sends a first FLOGI request to the port on the initiator. The first FLOGI request is with the second WWPN. In the embodiment shown in FIG. 2, FC port B 23 on target 20 sends the first FLOGI request to FC port H 15 on initiator 10.

Referring to FIG. 3(B), at step 323, the second port on the target receives a first FLOGI response from the port on the initiator. The port on the initiator sends the first FLOGI response to accept the first FLOGI request. In the FLOGI response, the WWPN of the port on the initiator is included. In the embodiment shown in FIG. 2, FC port B 23 on target 20 receives the first FLOGI response from FC port H 15 on initiator 10.

Referring to FIG. 3(B), at step 324, the target determines that the port on the initiator is connected to the second port on the target, based on a payload of the first FLOGI response from the port on the initiator. In the embodiment shown in FIG. 2, target 20 determines that FC port H 15 on initiator 10 is connected to FC port B 23 on target 20.

Referring to FIG. 3(B), at step 325, the target checks the point to point mapping table to determine that the port on the initiator has been connected to the first port on the target before the FC link is down and the first WWPN is unused in the pool. In checking the point to point mapping table, the WWPN (which is included in the payload of the first FLOGI response) of the port on the initiator is used. In the embodiment shown in FIG. 2, target 20 checks the point to point mapping table and determines that FC port H 15 on initiator 10 has been connected to FC port A 21 on target 20 before the FC link is down and TWWPN1 is unused in the pool.

Referring to FIG. 3(B), at step 326, the second port on the target sends a logout request to the port on the initiator and relinquishes the second WWPN. The second port on the target requests the port on the initiator to log out. The second WWPN will be returned back to the pool. In the embodiment shown in FIG. 2, port B 23 on target 20 sends the logout request to FC port H 15 on initiator 10 and takes TWWPN2 back.

Referring to FIG. 3(B), at step 327, the target assigns the first WWPN to the second port on the target. The first WWPN has been assigned to the first port on the target before the FC link down and is currently unused in the pool. In the embodiment shown in FIG. 2, target 20 assigns TWWPN1 to FC port B 23 on target 20.

Referring to FIG. 3(B), at step 328, the second port on the target sends a second FLOGI request to the port on the initiator. The second FLOGI request is with the first WWPN. In the embodiment shown in FIG. 2, port B 23 on target 20 sends to FC port H 15 on initiator 10 the second FLOGI request with TWWPN1.

Referring to FIG. 3(B), at step 329, the second port on the target receives a second FLOGI response from the port on the initiator. The port on the initiator sends the second FLOGI response to accept the second FLOGI request. In the embodiment shown in FIG. 2, port B 23 on target 20 receives the second FLOGI response from FC port H 15 on initiator 10. Thus, the target initiated FLOGI is completed successfully. The operating steps will continue, from \textcircled{B} in FIG. 2(B) to \textcircled{B} in FIG. 2(A). After step 329, steps 331 and 333 will be implemented.

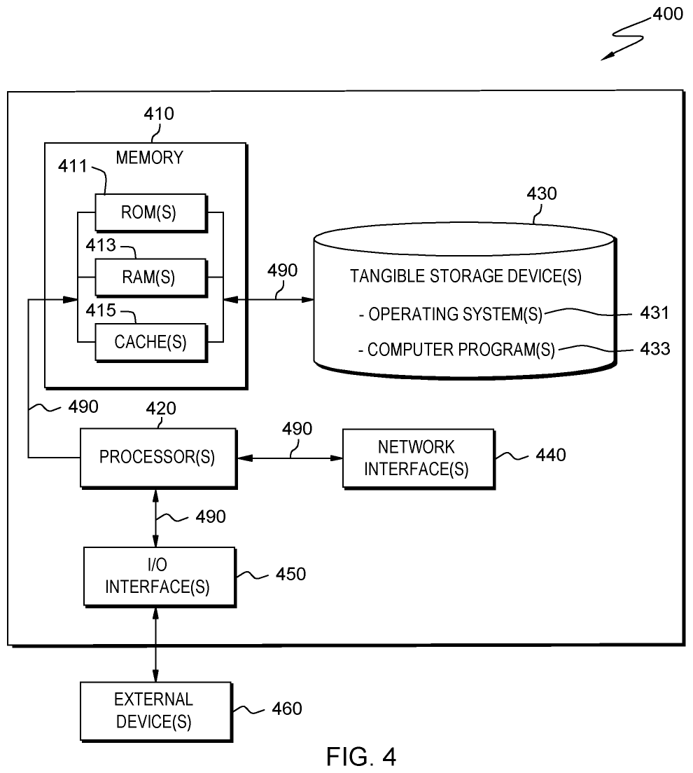

FIG. 4 is a diagram illustrating components of computing device 400 hosting initiator 10 or target 20 shown in FIG. 1, in accordance with one embodiment of the present invention. It should be appreciated that FIG. 4 provides only an illustration of one implementation and does not imply any limitations with regard to the environment in which different embodiments may be implemented.

Referring to FIG. 4, computing device 400 includes processor(s) 420, memory 410, and tangible storage device(s) 430. In FIG. 4, communications among the above-mentioned components of computing device 400 are denoted by numeral 490. Memory 410 includes ROM(s) (Read Only Memory) 411, RAM(s) (Random Access Memory) 413, and cache(s) 415. One or more operating systems 431 and one or more computer programs 433 reside on one or more computer readable tangible storage device(s) 430.

Computing device 400 further includes I/O interface(s) 450. I/O interface(s) 450 allows for input and output of data with external device(s) 460 that may be connected to computing device 400. Computing device 400 further includes network interface(s) 440 for communications between computing device 400 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the C programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for seamless I/O in Fibre Channel point to point topology, the method comprising:
returning, by a target, a first World Wide Port Name for a first port on the target to a pool of World Wide Port Names for ports on the target, in response to detecting that a Fibre Channel link between a port on an initiator and the first port on the target is down;
detecting, by the target, a connection between the port on the initiator and a second port on the target;
determining, by the target, whether the port on the initiator issues a request of an initiator initiated Fabric login for connecting to the second port on the target;
in response to determining that the port on the initiator does not issue the request of the initiator initiated Fabric login, assigning, by the target, a second World Wide Port Name to the second port on the target, wherein the second World Wide Port Name is currently unused in the pool;
sending to the port on the initiator, by the target, through the second port on the target, a first Fabric login request, wherein the first Fabric login request is with the second World Wide Port Name;
receiving from the port on the initiator, by the target, through the second port on the target, a first Fabric login response, in which the port on the initiator accepts the first Fabric login request;
determining, by the target, the port on the initiator is connected to the second port on the target, based on a payload of the first Fabric login response;
checking, by the target, a point to point mapping table to determine whether the port on the initiator has connected to the first port on the target before the Fibre Channel link is down and the first World Wide Port Name is currently unused in the pool;
in response to determining that the port on the initiator has connected to the first port on the target before the Fibre Channel link is down and the first World Wide Port Name is currently unused in the pool, sending, by the target, through the second port on the target, a logout request to the port on the initiator;
returning, by the target, the second World Wide Port Name to the pool;
assigning, by the target, the first World Wide Port Name to the second port on the target;
sending to the port on the initiator, by the target, through the second port on the target, a second Fabric login request, wherein the second Fabric login request is with the first World Wide Port Name; and
receiving from the port on the initiator, by the target, through the second port on the target, a second Fabric login response, in which the port on the initiator accepts the second Fabric login request, such that the target initiated Fabric login is completed.

2. The computer-implemented method of claim 1, further comprises:
in response to determining that the port on the initiator issues the request of the initiator initiated Fabric login, performing, by the target, the initiator initiated Fabric login, checking, by the target, a point to point mapping table to determine whether the port on the initiator has connected to the first port on the target before the Fibre Channel link is down and the first World Wide Port Name is currently unused in the pool;
in response to determining that the port on the initiator has connected to the first port on the target before the Fibre Channel link is down and the first World Wide Port Name is currently unused in the pool, assigning, by the target, the first World Wide Port Name to the second port on the target; and
responding, by the target, with the first World Wide Port Name, to the request of the initiator initiated Fabric login, such that the initiator initiated Fabric login is completed.

3. The computer-implemented method of claim 2, further comprising:
starting, by the port on the initiator, Fibre Channel protocol logins, including a port login and a process login, in response to determining that the initiator initiated Fabric login is successfully completed; and
resuming, by the port on the initiator, I/O in the Fibre Channel point to point topology, in response to determining that the Fibre Channel protocol logins are successfully completed.

4. The computer-implemented method of claim 2, wherein a World Wide Port Name of the port on the initiator is included in a payload of the request of the initiator initiated Fabric login, wherein the World Wide Port Name of the port on the initiator is used in checking the point to point mapping table, wherein the point to point mapping table is maintained on the target and defines mapping of the World Wide Port Names for the ports on the target to the World Wide Port Name of the port on the initiator.

5. (canceled)

6. The computer-implemented method of claim 1, further comprising:
starting, by the port on the initiator, Fibre Channel protocol logins, including a port login and a process login, in response to determining that the target initiated Fabric login is successfully completed; and
resuming, by the port on the initiator, I/O in the Fibre Channel point to point topology, in response to determining that the Fibre Channel protocol logins are successfully completed.

7. The computer-implemented method of claim 1, wherein a World Wide Port Name of the port on the initiator is included in the payload of the first Fabric login response, wherein the World Wide Port Name of the port on the initiator is used in checking the point to point mapping table, wherein the point to point mapping table is maintained on the target and defines mapping of the World Wide Port Names for the ports on the target to the World Wide Port Name of the port on the initiator.

8. A computer program product for seamless I/O in Fibre Channel point to point topology, the computer program product comprising one or more computer-readable tangible storage devices and program instructions stored on at least one of the one or more computer-readable tangible storage devices, the program instructions executable to:
return, by a target, a first World Wide Port Name for a first port on the target to a pool of World Wide Port Names for ports on the target, in response to detecting that a Fibre Channel link between a port on an initiator and the first port on the target is down;
detect, by the target, a connection between the port on the initiator and a second port on the target;
determine, by the target, whether the port on the initiator issues a request of an initiator initiated Fabric login for connecting to the second port on the target;
in response to determining that the port on the initiator does not issue the request of the initiator initiated Fabric login, assign, by the target, a second World Wide Port Name to the second port on the target, wherein the second World Wide Port Name is currently unused in the pool;
send to the port on the initiator, by the target, through the second port on the target, a first Fabric login request, wherein the first Fabric login request is with the second World Wide Port Name;
receive from the port on the initiator, by the target, through the second port on the target, a first Fabric login response, in which the port on the initiator accepts the first Fabric login request;
determine, by the target, the port on the initiator is connected to the second port on the target, based on a payload of the first Fabric login response;
check, by the target, a point to point mapping table to determine whether the port on the initiator has connected to the first port on the target before the Fibre Channel link is down and the first World Wide Port Name is currently unused in the pool;
in response to determining that the port on the initiator has connected to the first port on the target before the Fibre Channel link is down and the first World Wide Port Name is currently unused in the pool, send, by the target, through the second port on the target, a logout request to the port on the initiator;
return, by the target, the second World Wide Port Name to the pool;
assign, by the target, the first World Wide Port Name to the second port on the target;
send to the port on the initiator, by the target, through the second port on the target, a second Fabric login request, wherein the second Fabric login request is with the first World Wide Port Name; and
receive from the port on the initiator, by the target, through the second port on the target, a second Fabric login response, in which the port on the initiator accepts the second Fabric login request, such that the target initiated Fabric login is completed.

9. The computer program product of claim 8, the program instructions executable to:
in response to determining that the port on the initiator issues the request of the initiator initiated Fabric login, check, by the target, a point to point mapping table to determine whether the port on the initiator has connected to the first port on the target before the Fibre Channel link is down and the first World Wide Port Name is currently unused in the pool;
in response to determining that the port on the initiator has connected to the first port on the target before the Fibre Channel link is down and the first World Wide Port Name is currently unused in the pool, assign, by the target, the first World Wide Port Name to the second port on the target; and
respond, by the target, with the first World Wide Port Name, to the request of the initiator initiated Fabric login, such that the initiator initiated Fabric login is completed.

10. The computer program product of claim 9, the program instructions executable to:
start, by the port on the initiator, Fibre Channel protocol logins, including a port login and a process login, in response to determining that the initiator initiated Fabric login is successfully completed; and
resume, by the port on the initiator, I/O in the Fibre Channel point to point topology, in response to determining that the Fibre Channel protocol logins are successfully completed.

11. The computer program product of claim 9, wherein a World Wide Port Name of the port on the initiator is included in a payload of the request of the initiator initiated Fabric login, wherein the World Wide Port Name of the port on the initiator is used in checking the point to point mapping table, wherein the point to point mapping table is maintained on the target and defines mapping of the World Wide Port Names for the ports on the target to the World Wide Port Name of the port on the initiator.

12. (canceled)

13. The computer program product of claim 8, for performing the target initiated Fabric login, the program instructions executable to:
start, by the port on the initiator, Fibre Channel protocol logins, including a port login and a process login, in response to determining that the target initiated Fabric login is successfully completed; and
resume, by the port on the initiator, I/O in the Fibre Channel point to point topology, in response to determining that the Fibre Channel protocol logins are successfully completed.

14. The computer program product of claim 8, wherein a World Wide Port Name of the port on the initiator is included in the payload of the first Fabric login response, wherein the World Wide Port Name of the port on the initiator is used in checking the point to point mapping table, wherein the point to point mapping table is maintained on the target and defines mapping of the World Wide Port Names for the ports on the target to the World Wide Port Name of the port on the initiator.

15. A computer system for seamless I/O in Fibre Channel point to point topology, the computer system comprising:
one or more processors, one or more computer readable tangible storage devices, and program instructions stored on at least one of the one or more computer readable tangible storage devices for execution by at least one of the one or more processors, the program instructions executable to:
return, by a target, a first World Wide Port Name for a first port on the target to a pool of World Wide Port Names for ports on the target, in response to detecting that a Fibre Channel link between a port on an initiator and the first port on the target is down;
detect, by the target, a connection between the port on the initiator and a second port on the target;
determine, by the target, whether the port on the initiator issues a request of an initiator initiated Fabric login for connecting to the second port on the target;
in response to determining that the port on the initiator does not issue the request of the initiator initiated Fabric login, assign, by the target, a second World Wide Port Name to the second port on the target, wherein the second World Wide Port Name is currently unused in the pool;
send to the port on the initiator, by the target, through the second port on the target, a first Fabric login request, wherein the first Fabric login request is with the second World Wide Port Name;
receive from the port on the initiator, by the target, through the second port on the target, a first Fabric login response, in which the port on the initiator accepts the first Fabric login request;
determine, by the target, the port on the initiator is connected to the second port on the target, based on a payload of the first Fabric login response;
check, by the target, a point to point mapping table to determine whether the port on the initiator has connected to the first port on the target before the Fibre Channel link is down and the first World Wide Port Name is currently unused in the pool;
in response to determining that the port on the initiator has connected to the first port on the target before the Fibre Channel link is down and the first World Wide Port Name is currently unused in the pool, send, by the target, through the second port on the target, a logout request to the port on the initiator;
return, by the target, the second World Wide Port Name to the pool;
assign, by the target, the first World Wide Port Name to the second port on the target;
send to the port on the initiator, by the target, through the second port on the target, a second Fabric login request, wherein the second Fabric login request is with the first World Wide Port Name; and
receive from the port on the initiator, by the target, through the second port on the target, a second Fabric login response, in which the port on the initiator accepts the second Fabric login request, such that the target initiated Fabric login is completed.

16. The computer system of claim 15, the program instructions executable to:
in response to determining that the port on the initiator issues the request of the initiator initiated Fabric login, perform, by the target, check, by the target, a point to point mapping table to determine whether the port on the initiator has connected to the first port on the target before the Fibre Channel link is down and the first World Wide Port Name is currently unused in the pool;
in response to determining that the port on the initiator has connected to the first port on the target before the Fibre Channel link is down and the first World Wide Port Name is currently unused in the pool, assign, by the target, the first World Wide Port Name to the second port on the target;
respond, by the target, with the first World Wide Port Name, to the request of the initiator initiated Fabric login, such that the initiator initiated Fabric login is completed; and
wherein a World Wide Port Name of the port on the initiator is included in a payload of the request of the initiator initiated Fabric login, wherein the World Wide Port Name of the port on the initiator is used in checking the point to point mapping table, wherein the point to point mapping table is maintained on the target and defines mapping of the World Wide Port Names for the ports on the target to the World Wide Port Name of the port on the initiator.

17. The computer system of claim 16, the program instructions executable to:
start, by the port on the initiator, Fibre Channel protocol logins, including a port login and a process login, in response to determining that the initiator initiated Fabric login is successfully completed; and
resume, by the port on the initiator, I/O in the Fibre Channel point to point topology, in response to determining that the Fibre Channel protocol logins are successfully completed.

18. (canceled)

19. The computer system of claim 15, for performing the target initiated Fabric login, the program instructions executable to:
start, by the port on the initiator, Fibre Channel protocol logins, including a port login and a process login, in response to determining that the target initiated Fabric login is successfully completed; and
resume, by the port on the initiator, I/O in the Fibre Channel point to point topology, in response to determining that the Fibre Channel protocol logins are successfully completed.

20. The computer system of claim 15, wherein a World Wide Port Name of the port on the initiator is included in the payload of the first Fabric login response, wherein the World Wide Port Name of the port on the initiator is used in checking the point to point mapping table, wherein the point to point mapping table is maintained on the target and defines mapping of the World Wide Port Names for the ports on the target to the World Wide Port Name of the port on the initiator.
